(19) United States
(12) Patent Application Publication
(10) Pub. No.: US 2013/0275905 A1
(43) Pub. Date: Oct. 17, 2013

(54) INTERACTIVE DATA COMPARISON AND INSIGHT TRACKING

(71) Applicant: SECONDPRISM INC., Santa Clara, CA (US)

(72) Inventors: Vivek Bhaskaran, Seattle, WA (US); Anup Surendran, Toronto (CA)

(73) Assignee: SECONDPRISM INC., Santa Clara, CA (US)

(21) Appl. No.: 13/779,765

(22) Filed: Feb. 28, 2013

Related U.S. Application Data
(60) Provisional application No. 61/622,532, filed on Apr. 11, 2012.

(51) Int. Cl. G06F 3/0484

(52) U.S. Cl. CPC G06F 3/0484
USPC 715/771

(57) ABSTRACT

A data comparison and insight system is described herein that visually facilitates comparison of two or more datasets and shares insights discovered by one user comparing the data with other users. The system receives input data that includes multiple dimensions, such as a matrix of responses to a survey question. A user may want to compare this data, setting two distinct points in one dimension so that the user can see the variation in the other dimension at these two points and compare it. Past systems treat these as two separate datasets and the visualization of these datasets is also done separately. The data comparison and insight system provides several chart types that integrate the data from both datasets and provide a unified visualization of the two or more datasets. This allows the system to present a data comparison visualization that provides a third dimension into the data.

### CROSS-REFERENCE TO RELATED APPLICATIONS

The present application claims the benefit of U.S. Provisional Patent Application No. 61/622,532 (Attorney Docket No. SURVEY010) entitled “INTERACTIVE DATA VISUALIZATION AND MANIPULATION”, and filed on Apr. 4, 2012, which is hereby incorporated by reference.

### BACKGROUND

Businesses today are inundated with massive amounts of data related to internal metrics, product sales, progress reports, and so forth. All areas of business are impacted by various types of data and employees of many different job functions all the way up to the chief executive are tasked with digesting this data and making meaningful decisions. Over the years, various business intelligence and data visualization tools have been developed that help to turn large amounts of numeric data into spreadsheets, graphs, pictures, and other more easily digestible forms than raw numeric data. The data may come from a wide variety of systems including finance systems, human resource systems, sales systems, customer feedback systems, and so forth. Often each of these functional departments has its own types of data and tools for reporting and consuming that data.

Modern mobile devices have made computing tasks possible on the go that once required bulky desktop computer systems. Smartphones and tablet computers have made it easy to always have a powerful computing device available. However, these devices do not make it any easier to consume the vast amount of information that most users receive. Whether in business contexts like those described above, or organizing personal information, users of mobile devices suffer some of the same problems consuming large amounts of data that have existed for a long time.

Touch-based mobile devices provide a level of intimacy and ease of input between users and computing devices that did not exist in the days when a keyboard and mouse were the main tools for input. The ability to touch and manipulate information and user interfaces through gestures such as pinching, multi-finger touch, sliding, and so forth have enabled users to more readily manipulate information but have still not produced a solution to the vast amounts of information to be consumed. To use information effectively, users of computing devices need ways to effectively summarize large amounts of data into usable subsets.

In addition, users often want to compare multiple sets of data and discuss their observations with others. Comparison of data may be handled in a variety of manual ways today. For example, a user may create a spreadsheet with side-by-side tables where each table shows one dataset. Another method is to use cross tabulation to generate a contingency table that shows a summary of each dataset in separate columns of a table. Other tools, such as CRYSTALREPORTS™ create two charts where a user is expected to digest and understand each set of information separately and then to make comparisons manually. Once a user has made a relevant discovery related to correlations within the data, the user may want to share that discovery with others. Today the user typically does that separate from the data, such as by sending an email, calling a meeting, or placing a phone call to another person. How the user discovered the correlation may be lost or may be difficult for others to grasp.

### BRIEF DESCRIPTION OF THE DRAWINGS

FIG. 1 is a block diagram that illustrates components of the data comparison and insight system, in one embodiment.

FIG. 2 is a flow diagram that illustrates processing of the data comparison and insight system to display comparison data for multiple datasets in a single chart, in one embodiment.

FIG. 3 is a flow diagram that illustrates processing of the data comparison and insight system to receive an insight for sharing with other users, in one embodiment.

FIG. 4 is a display diagram that illustrates a graphical user interface provided by the data comparison and insight system to illustrate a matrix question, in one embodiment.

FIG. 5 is a display diagram that illustrates a graphical user interface provided by the data comparison and insight system to illustrate a dynamic inset visualization displaying a single dataset, in one embodiment.

FIG. 6 is a display diagram that illustrates a graphical user interface provided by the data comparison and insight system to illustrate a side-by-side comparison visualization, in one embodiment.

FIG. 7 is a display diagram that illustrates a graphical user interface provided by the data comparison and insight system to illustrate an overlay comparison visualization, in one embodiment.

FIG. 8 is a display diagram that illustrates a graphical user interface provided by the data comparison and insight system to illustrate a marker comparison visualization, in one embodiment.

FIG. 9 is a display diagram that illustrates a graphical user interface provided by the data comparison and insight system to illustrate activating filtering, in one embodiment.

FIG. 10 is a display diagram that illustrates a graphical user interface provided by the data comparison and insight system to illustrate defining a filter, in one embodiment.

FIG. 11 is a display diagram that illustrates a graphical user interface provided by the data comparison and insight system to illustrate editing filters, in one embodiment.

FIG. 12 is a display diagram that illustrates a graphical user interface provided by the data comparison and insight system to illustrate adding insights and sharing data, in one embodiment.

FIG. 13 is a display diagram that illustrates a graphical user interface provided by the data comparison and insight system to illustrate searching for shared datasets, in one embodiment.

### DETAILED DESCRIPTION

A data comparison and insight system is described herein that visually facilitates comparison of two or more datasets and shares insights discovered by one user comparing the data with other users. In some embodiments, the system receives input data that includes multiple dimensions, such as a matrix of responses to a survey question. For example, a survey respondent asked to rate an opinion of a list of TV channels might be asked to give each channel a rating from one to five. This question has two dimensions, the channels (e.g., in the vertical dimension) and the rating (e.g., in the horizontal dimension). As another example, a user may be asked to indicate which days a respondent performs each of a list of activities, such as going to the gym, dining at a restaurant, and so forth. This question includes one dimension that is the activity and another dimension that is the days of the week. A user may want to compare this data, setting two distinct points in one dimension so that the user can see the variation in the other dimension at these two points and compare it. For example, a user receiving responses to the rating of channels may want to compare channels rated the lowest rating with channels rated the highest rating. There are two input datasets. The first input dataset is a summary of all of the responses that specified the lowest rating, which may be a count for each channel (e.g., 25 respondents rated NBC low, 32 respondents rated ABC low, and so forth). The second input dataset is a summary of all of the responses that specified the highest rating, which may also be a count for each channel (e.g., 40 respondents rated NBC high, 30 respondents rated ABC high, and so on).

Past systems treat these as two separate datasets and the visualization of these datasets is also done separately. For example, a traditional analytics system might produce two separate charts, one for each dataset, and leave it up to the user to consume both charts at the same time and draw any conclusions. This is inefficient for the user, and may obscure certain correlations that would be more easily seen if the datasets could be viewed together. The data comparison and insight system provides several chart types that integrate the data from both datasets and provide a unified visualization of the two or more datasets. For example, the system may display a bar chart where the first dataset provides a baseline bar for each data point that is shown side by side with bars representing data points of the second dataset. Note that rather than two separate charts, data for one dataset is shown side by side with data from the other dataset. As another example, the system may display a marker visualization, in which data from one data set is displayed as a high water mark over top of bar or other data from the other dataset. Rather than a marker, the system may actually overlay two bars or other chart components on top of each directly using different colors or patterns and degrees of transparency to make both visible at the same time (e.g., a background dataset may be solid while a foreground dataset is 50% transparent). This allows the system to present a data comparison visualization that provides a third dimension into the data (i.e., the comparison or view of the multidimensional at two data points creates an additional dimension that is displayed more clearly to the user).

In addition, once a user determines a particular interesting nuance of the data by comparing the datasets, the user can store a comment or insight right at the point of the insight. For example, a user may associate an insight about a particular comparison of two related points within two datasets. The system stores received insights in a database and shares them with other users viewing the same datasets. The system may also provide sharing features that allow one user to post a link to the insight or to send a message or other communication so that other users are directed to view the insight and underlying data and visualizations. In this way, rich analytics information is captured right at the point of discovery, and can be communicated with other users without leaving the system. This removes ambiguity by allowing the other users to see exactly what the first user saw when the first user discovered the insight. The other users may make comments or insights of their own to further evolve the group's understanding of the data. Thus, the data comparison and insight system facilitates finding and sharing interesting discoveries within large datasets, and provides a level of ease and tracking to the process that was previously unavailable.

The data comparison and insight system can provide the functionality described above and further herein through a rich touch-based interface, such as that becoming more commonly available on mobile devices such as APPLE™ IPAD™ and GOOGLE™ ANDROID™ tablets and smartphones. One data visualization system that can be used with the data comparison and insight system is described in a related application assigned U.S. patent application Ser. No. 13/779,763 (Attorney Docket No. SURVEY011), entitled “INTERACTIVE DATA VISUALIZATION AND MANIPULATION”, and filed on Feb. 28, 2013, which is hereby incorporated by reference. The system described herein can be used to augment the data visualization and charting functionality described therein. For example, in some embodiments the data comparison and insight system adds a dynamic inset visualization, displayed as an inset to the side or other position of a main displayed visualization.

The dynamic inset visualization changes as the user selects various data points within the main data being visualized. In addition, the user interface may provide controls for marking a particular dataset as a baseline dataset and then selecting one or more other datasets for comparison to the baseline dataset. The dynamic inset visualization may also include additional user interface controls for selecting a chart type and other options for the dynamic inset visualization. For example, the user interface may include controls for selecting between the side-by-side, marker, and overlay comparison visualizations described above. Although certain types of display are described as examples herein, those of ordinary skill in the art will recognize other possible user interface combinations, layouts of controls, positioning of displayed data, and so forth. For example, in some embodiments the user may select the data comparison visualization as the main visualization rather than displaying it as a dynamic inset. These and other variations are consistent with the abilities provided by the system as described herein.

In some embodiments, the data comparison and insight system displays a tag cloud that indicates votes of users on particular data points. For example, a tag cloud may display a textual tag and a number of votes that indicate how many users found that tag relevant. A user can then click or select a particular tag to drill down on that tag and view additional datasets associated with the tag or navigate to a different visualization element. The tag cloud can also be used as a navigation method for easily finding user submitted publicly available chart information.

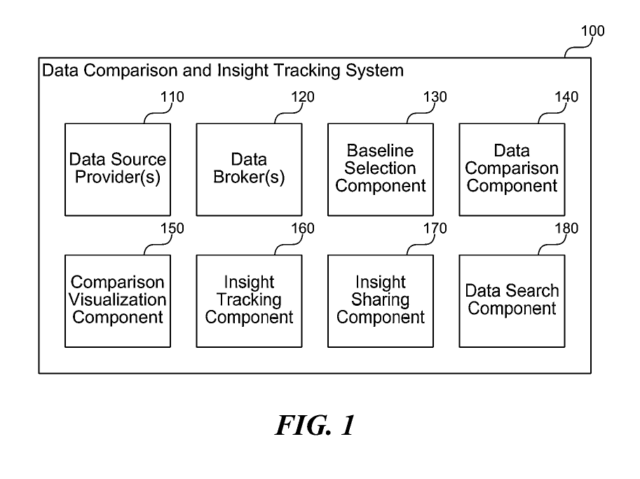

FIG. 1 is a block diagram that illustrates components of the data comparison and insight system, in one embodiment. The system 100 includes one or more data source providers 110, one or more data brokers 120, a baseline selection component 130, a data comparison component 140, a comparison visualization component 150, an insight tracking component 160, an insight sharing component 170, and a data search component 180. Each of these components is described in further detail herein.

The one or more data source providers 110 gather data from one or more data sources. For example, the system 100 may provide data source providers for gathering data from software as a service (SaaS) applications, QuestionPro, Google Analytics, Salesforce, The Huffington Post, Open.gov, or other data sources. The system 100 may also provide a JavaScript Object Notation (JSON)/representation state transfer (REST) interface through which web-based applications can provide data to and interact with the system 100. Third parties can leverage the system 100 by supplying their own data and using a charting and visualization library provided by the system 100 to examine their data in new ways.

The one or more data brokers 120 modify data received from the one or more data sources to prepare the received data for display in a visualization. The system may provide various data brokers 120, such as those for authentication (e.g., identifying a user and user profile, along with stored settings and other information), filtering, attaching visualizations, and so forth. In some embodiments, the system 100 provides advanced filtering capabilities through which a user can define filters, such as key-value pairs, logical conditions that the system 100 compares to the data. Data that matches may be flagged for inclusion or exclusion, depending on whether the filter is a positive or negative filter. The filtered data can then be visualized and compared. This allows, for example, removing an entire subset of the data so that patterns and trends in the remaining data become more apparent to a user viewing visualizations based on the filtered data. In some embodiments, the system 100 provides a broker or other component that receives branding information, such as graphics, text, logos, and so forth, for display in association with the visualizations and other user interfaces of the system 100. This allows third parties to create branded sites using the visualizations provided by the system 100.

The baseline selection component 130 receives a selection of a dataset that will form a baseline against which to compare one or more other datasets received from the data source providers 110. The baseline selection component 130 may allow the user to visually select data in a visualization and to define multidimensional data at a particular data point as a baseline for comparing with multidimensional data at other data points. For example, a user viewing customer satisfaction data that indicates how satisfied users are on a scale with various interactions with a company (e.g., via website, calling customer service, physical store staff, and so forth), may select a “very unsatisfied” level of the scale as a baseline and the select other data points, such as the “very satisfied” level of the scale for comparison. At each data point, the system calculates a percentage or count of users that had the selected level of satisfaction for each interaction type with the company. This could expose correlations, such as a large number of users being very unsatisfied with the website, but a similarly large set of users being very satisfied with the company's retail presence. Upon receiving a selection of baseline data, the system 100 may generate a separate visualization, such as the dynamic inset visualization described herein, in which to show data comparisons.

The data comparison component 140 compares the selected baseline dataset with the one or more comparison datasets. The comparison may include computing data for each dataset, determining which parts of the dataset are selected for visualization, and generating data for displaying each dataset to the user. For example, if the user has defined one or more filters, then the data comparison component 140 may identify points within one dimension of the data that are being compared, apply the defined filters at each of those points, and then summarize or tally the remaining data along the remaining dimensions. Note that the system 100 may maintain its own view of data, such that the original data is not modified. This allows the system 100 to be applied on top of one or more existing data sources without modifications to those data sources. The system 100 acts as yet another consumer of those data sources, but provides visualizations and other displays that were not provided by the source data system.

The comparison visualization component 150 generates one or more visualizations for visually comparing data in two or more datasets. For multidimensional datasets, the component 150 combines visualization data for multiple datasets and displays multiple data dimensions side by side for comparison. Survey data having multiple answer choices for multiple similar entries can create three or more dimensions of data. For example, a question that asks a user which days the user performs each of five activities has one dimension that is the days of the week, one dimension that is the activities, and another dimension that is created by summarizing the data from multiple users responding to the survey. The user may select to freeze one dimension at two or more values to observe how the other two dimensions compare at those values. For example, if the user selects a baseline of Monday, and a comparison value of Friday, then the user can view how many respondents perform activity A on Monday vs. Friday or the relative distribution of all of the activities on Monday vs. Friday (e.g., 30% of respondents go to the gym on Monday vs. 10% who go on Friday). The comparison visualization component 150 generates visualizations that facilitate comparing this type of data, such as the marker and overlay visualizations described earlier.

The insight tracking component 160 collects and stores data insights from users including an identification of particular data associated with each insight. An insight includes an observation by a user of some meaningful occurrence within displayed data. The user may observe a pattern, correlation, trend, or other interesting behavior within the data that the user wants to save and potentially share with other users. The system 100 allows the user to add an insight at that location, and associates the insight with the location. By linking to the location, the system 100 can allow other users to view the same visualization whenever the insight is accessed. In some embodiments, the system 100 also allows users to add comments to data. A comment contains textual or other information that a user wants to associate with a particular displayed visualization. The insight tracking component 160 includes a data store, such as a database or other store, that stores insights and allows them to be shared with and displayed with associated data to other users.

In some embodiments, the system may infer insights based on time spent by a user looking at particular data or other analysis. The system may also rank insights by information such as time spent viewing the insights to produce a “best insights” or similar ranking to help other users find interesting data. Users may also select particular visualizations as favorites, and embed visualizations in areas such as email or web-based reports.

The insight sharing component 170 communicates insights from one user to another including the identification of particular data associated with each insight. For example, one user might share an insight on Facebook or by email for other users to view. The shared insight may include a hyperlink or other reference that allows the other users to click or select the insight, and be taken to a web page or other user interface through which the users can view the same or similar visualization as the original user that made the insight. The users may also comment or add insights or their own. In addition, through the visualization the other users may apply additional filters or otherwise manipulate the displayed visualization to produce new visualizations for comparing the data.

The data search component 180 provides a searchable repository of datasets. The data sets may be public, such that they are available to any user of the system 100, or private, such that they require some level of authentication or group membership. The data search component 180 allows users to find existing data that meets particular criteria and allows reuse of previously collected data for new types of analysis. In some embodiments, the system 100 provides a website through which data searches may be submitted and applicable datasets may be obtained as search results. In some embodiments, data search includes a unique chart ranking algorithm, which takes into account the usage of the chart data, popularity of the underlying dataset, insights, and the social sharing of the chart to rank charts, data, and visualizations.

The computing device on which the data comparison and insight system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored on computer-readable storage media. Any computer-readable media claimed herein include only those media falling within statutorily patentable categories. The system may also include one or more communication links over which data can be transmitted. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

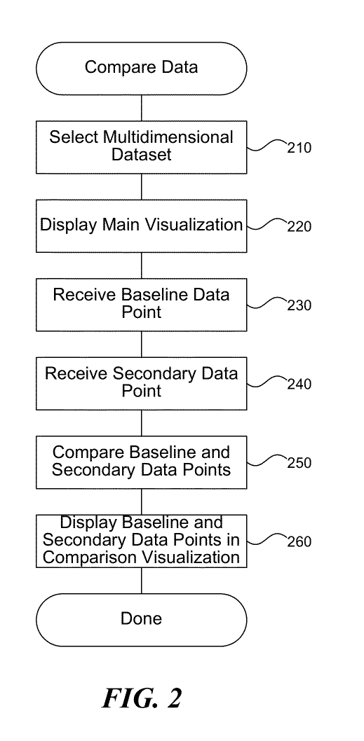

FIG. 2 is a flow diagram that illustrates processing of the data comparison and insight system to display comparison data for multiple datasets in a single chart, in one embodiment. Beginning in block 210, the system receives a selection of a multidimensional dataset to compare with another multidimensional dataset. For example, a user may select each dataset from a repository of datasets provided by an analytics tool or data search website. The multidimensional dataset may represent a variety of types of data, such as responses to matrix survey questions. The system may access externally stored data through a data source provider and/or broker that gathers and formats the data to prepare the data for use by the system.

Continuing in block 220, the system displays a main visualization that displays a range of data points of the selected multidimensional dataset. For example, the system may display a line chart with a line for each two dimensional view of the data. The system may leverage a touch interface that allows the user to touch the chart to see additional data, to flip over the chart to access underlying data, and so forth. The user may also rotate the chart to change a currently highlighted portion. The system may provide the main visualization as the majority of the display area of a mobile device, with user interface controls that the user can touch or otherwise select to access the other functions of the system.

Continuing in block 230, the system receives a selection of a baseline data point to use as a basis for comparing other data points. For example, the system may allow the user to select data directly from the displayed main visualization to be used for comparison. In the example of a line chart, the system may display a vertical line that shows a selection point along the x-axis. The x-axis can represent a variety of types of data, such as possible responses to a multiple-choice question (e.g., A through E or “very unsatisfied” to “very satisfied”). The user may select a user interface control that indicates to the system that the current selection point will be used as a baseline for comparison. For example, if the user has the selection point all the way at the left of the x-axis of the line chart, then the system will use data associated with that x-value for the baseline data point.

Continuing in block 240, the system receives a selection of a secondary data point to compare with the baseline data point. For example, the user may move the selection line along the x-axis to the right, selecting a different multiple-choice response. The user may then select a user interface control that indicates that the current selection point will be used as comparison data to compare against the baseline data point. The system will then use the data associated with that x-value for comparing with the baseline. In some embodiments, the user may compare more than two sets of data, such that the system continues to receive selections of additional data points from the user to compare to the baseline and other selected data points.

Continuing in block 250, the system gathers data associated with the selected baseline and secondary data point, and prepares the data for visual display. For example, the system may tally responses that match the selected data point, calculate percentages that indicate a distribution of values, and so forth. If the user has applied any filters, then the system calculates the effect of the filters on the data and modifies the data in accordance with the filter. For example, the filter may indicate that certain data be removed or grouped.

Continuing in block 260, the system displays the selected baseline and secondary data points together in a unified comparison visualization. The data points from each dataset are displayed together in the same chart or other visualization and do not make the user view a separate visualization for each data point and/or dataset. This allows the user to quickly and visually compare the data between the baseline and secondary data points. In some embodiments, the system displays the comparison data visualization alongside the main visualization, such as via an inset window or smaller display adjacent to the main visualization. The system may also flip the main visualization over or allow the user to swipe between the comparison visualization and the main visualization. Unlike prior systems, data from each selected data point is mixed together and displayed in the same visualization. For example, the baseline data may overlay the secondary data or may display as a marker on top of the secondary data. The user may select additional secondary data points, and the data comparison visualization may dynamically update to show a comparison between the user's current selection at any point in time and the previously identified baseline data. After block 260, these steps conclude.

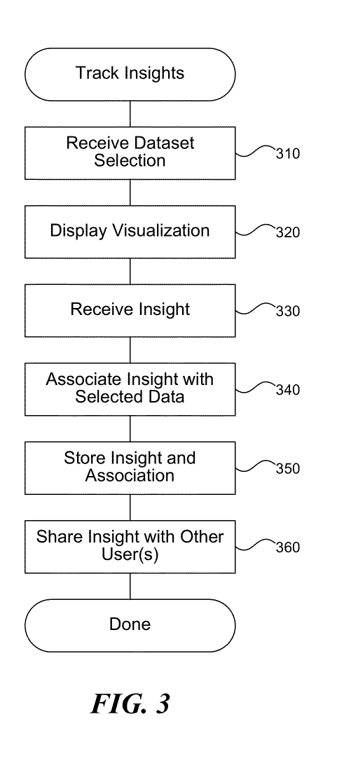

FIG. 3 is a flow diagram that illustrates processing of the data comparison and insight system to receive an insight for sharing with other users, in one embodiment. Beginning in block 310, the system receives a selection of a dataset to analyze. The system may offer a list of available datasets, such as publicly and privately published datasets or a user of the system may provide a custom dataset based on survey or other data specific to the user's task. In some embodiments, the system provides a search portal through which the user can search available datasets.

Continuing in block 320, the system displays a visualization related to the selected dataset that visually displays at least part of the data in the dataset. The visualization may include a chart, graph, or other visual display. The system may display the visualization on a mobile or other computing device with touch input or other hardware that allows the user to interact with the displayed visualization. The system may also display one or more user interface controls that allow the user to interact with the data and access other functions of the system. For example, the user may filter, group, or combine the data with other data to produce particular input data that the user is interested in.

Continuing in block 330, the system receives an insight from the user that logs a relevant point in the data identified by the user. The user may select an “add insight” or similar user interface control and may provide a textual or other description (e.g., audio, video, or other) associated with the user's insight. The insight may represent any observed interesting data, pattern, trend, correlation, or other occurrence of significance to the user. The user adds an insight upon discovery of the relevant data so that the insight can be recorded for future use and shared with other users. The user may also provide descriptive text or other information that described the insight and that can be seen by other users with which the user shares the insight.

Continuing in block 340, the system associates the received insight with the relevant point in the data to which the insight pertains. By associating insights with particular visualizations and data points, the system increases the value of a user's observations by allowing other users to come back to the data and visualizations that allowed the user to discovery the insight. This allows other users to see what the first user saw and even to make follow on observations by modifying the data in additional ways. For example, a second user may further filter the first user's data, and may generate new visualizations that make a particular aspect of the data even more visible.

Continuing in block 350, the system stores the received insight and association with the relevant point in the data for future use by the user and other users. The system may store a database or other data store of received insights, and may allow users to access the stored list of insights. In some cases, the system creates links or other references to each insight that allow users to share specific insights and to access specific insights easily.

Continuing in block 360, the system receives a request to share a stored insight with another user, and sends a reference to the insight to the user in a communication. Upon receiving the communication, such as an email, the receiving user can open the communication, access the reference to the insight, and invoke the system to display the insight along with any associated data and visualizations. This takes the receiving user to the relevant point in the data identified by the user that created the insight, and allows the receiving user to review the insight in its original context. After block 360, these steps conclude.

The following paragraphs provide descriptions and visual examples of various aspects of the data comparison and insight system.

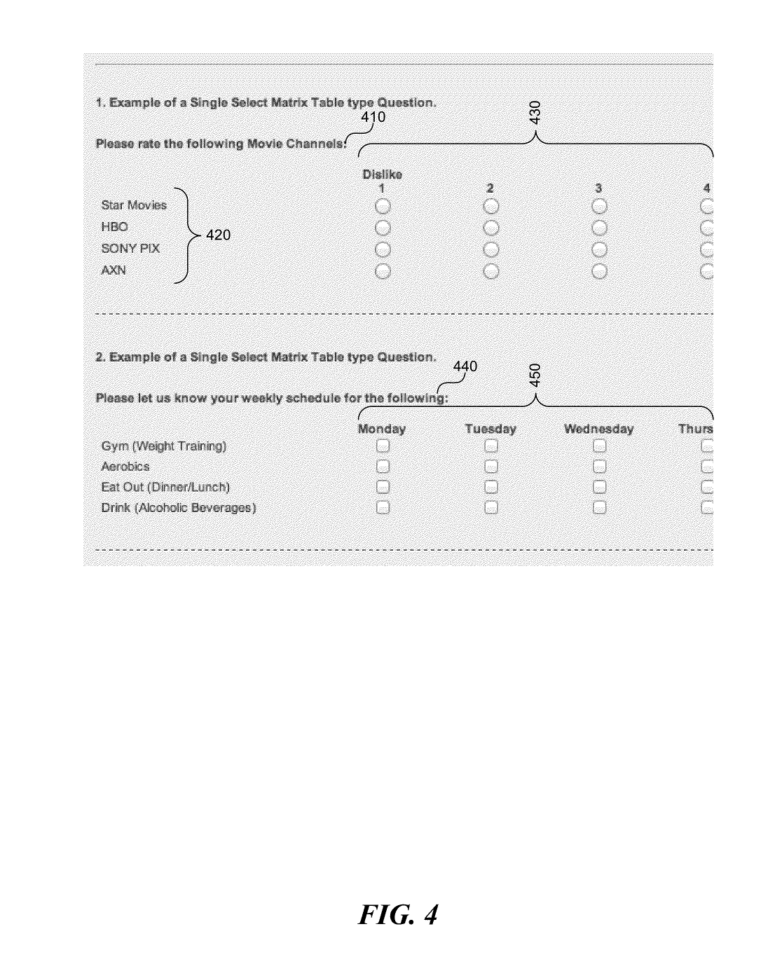

FIG. 4 is a display diagram that illustrates a graphical user interface provided by the data comparison and insight system to illustrate a matrix question, in one embodiment. A first question 410 asks a respondent to rate movie channels available for television. The response includes a vertical dimension 420 of channels and a horizontal dimension 430 indicating the respondent's opinion of the channel. The respondent's responses will result in a matrix where there may be one or more choices for each dimension. For example, the first question 410 includes radio buttons where the respondent will provide one opinion per channel, whereas the second question 440 includes check boxes 450 where the respondent may indicate that the respondent performs each activity zero, one, or more times per week. After numerous users answer the same survey questions, the resulting data will form various datasets, such as a dataset indicating statistics about users that disliked specific channels. There may be 45 that disliked the first channel, 10 that disliked the second, and so forth forming one dataset. Another dataset may include the users that liked particular channels.

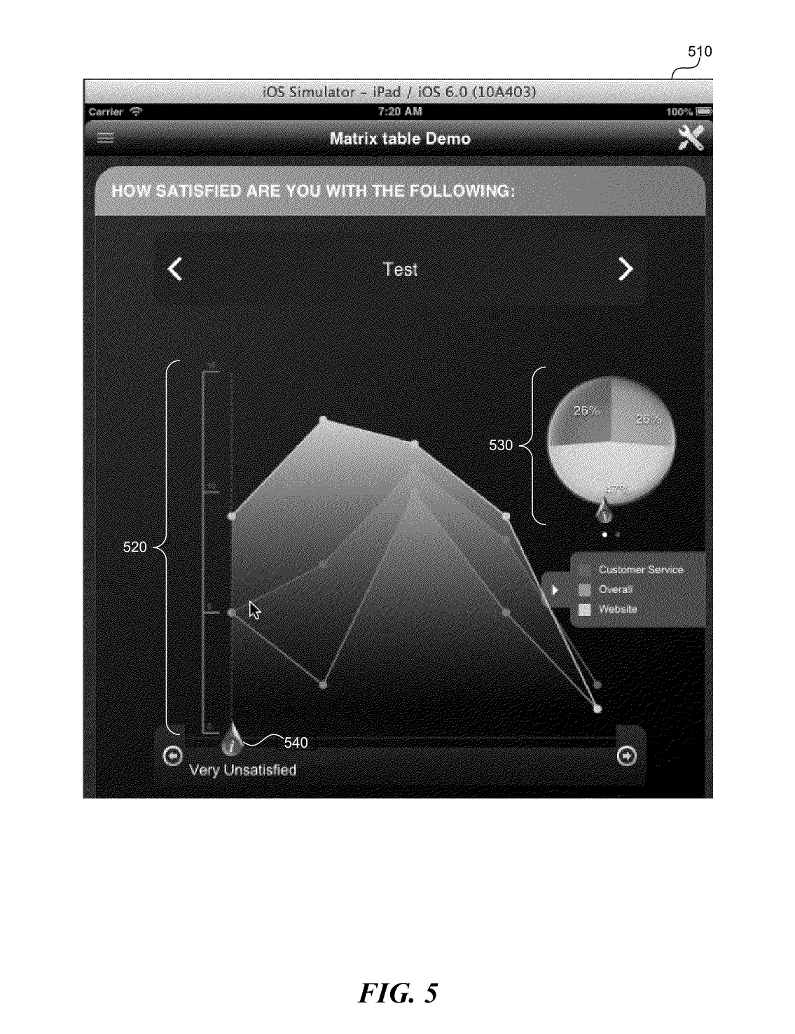

FIG. 5 is a display diagram that illustrates a graphical user interface provided by the data comparison and insight system to illustrate a dynamic inset visualization displaying a single dataset, in one embodiment. The display 510 includes a main visualization 520 that displays a line chart of matrix survey data for satisfaction levels with an organization's customer-facing operations, such as a website and customer service department. The display 510 also includes a dynamic inset visualization 530 that shows the relative responses of respondents at a selection point 540. The user may move the selection point 540 along the x-axis, and the dynamic inset visualization 530 will dynamically update to show data associated with that point. Each point along the x-axis can be identified as a separate dataset. In FIG. 5, the dynamic inset visualization 530 is used to display information about one dataset at a time.

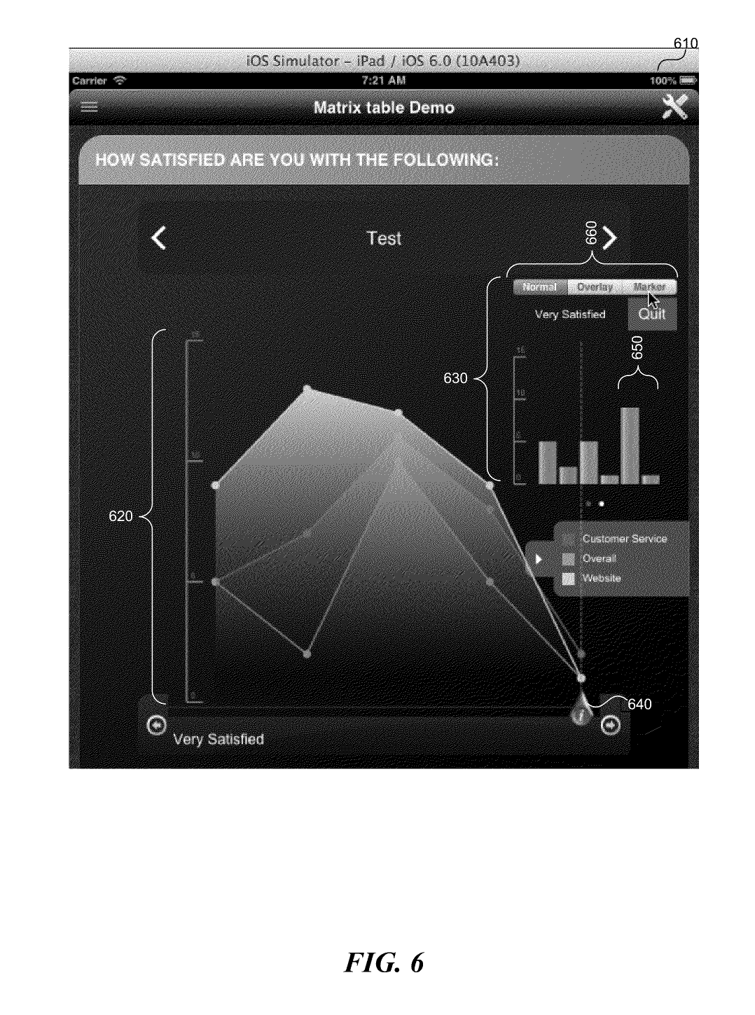

FIG. 6 is a display diagram that illustrates a graphical user interface provided by the data comparison and insight system to illustrate a side-by-side comparison visualization, in one embodiment. The display 610 includes a main visualization 620 that displays a line chart of matrix survey data for satisfaction levels with an organization's customer-facing operations, such as a website and customer service department. The display 610 also includes a dynamic inset visualization 630 that shows the relative responses of respondents. The dynamic inset visualization is showing two datasets integrated into the same chart. The set of bars 650 illustrates a baseline data point on the left, and a comparison data point on the right. As the user moves the selection point 640, the right bar changes while the baseline data stays the same. This allows the user to see any particular dataset in comparison to the baseline. The user can also set a new baseline at any time. The display 610 provides controls 660 that allow the user to select other visualization types, such as the marker and overlay types described further herein.

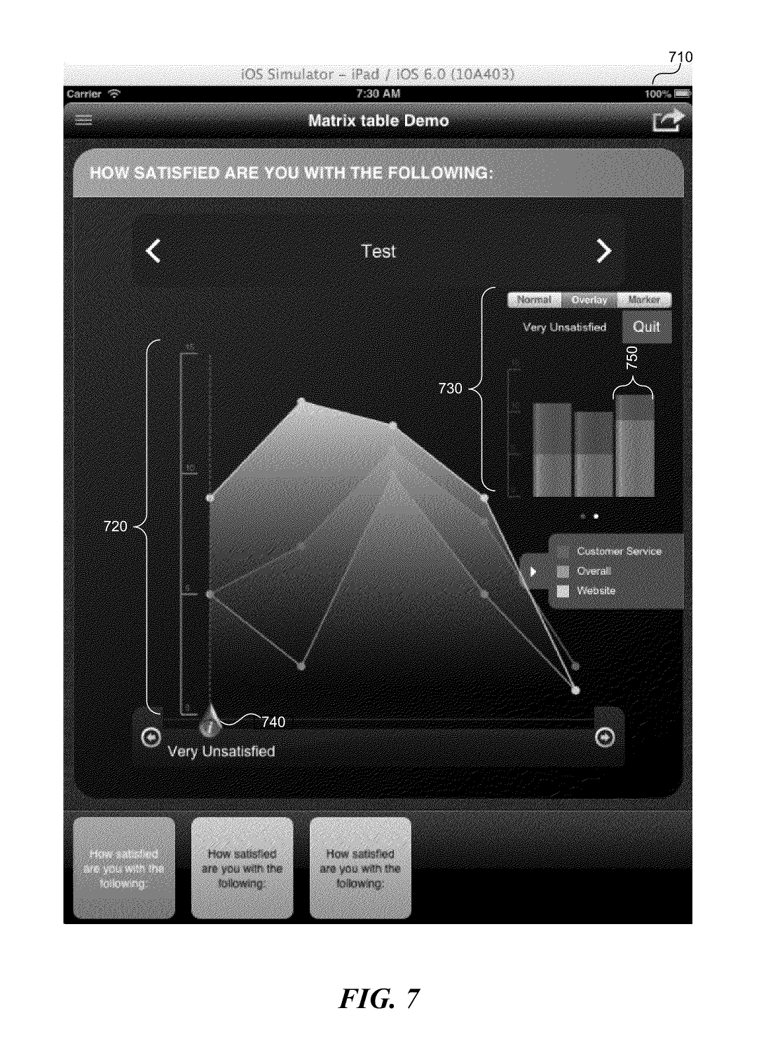

FIG. 7 is a display diagram that illustrates a graphical user interface provided by the data comparison and insight system to illustrate an overlay comparison visualization, in one embodiment. The display 710 includes a main visualization 720 that displays a line chart of matrix survey data for satisfaction levels with an organization's customer-facing operations, such as a website and customer service department. The display 710 also includes a dynamic inset visualization 730 that shows the relative responses of respondents. The dynamic inset visualization is showing two datasets integrated into the same chart. Each bar 750 illustrates a baseline data point as a darker, more translucent bar and a comparison data point as a light, more solid bar overlaid on top. As the user moves the selection point 740, the overlaid bar changes while the baseline data stays the same. This allows the user to see any particular dataset in comparison to the baseline.

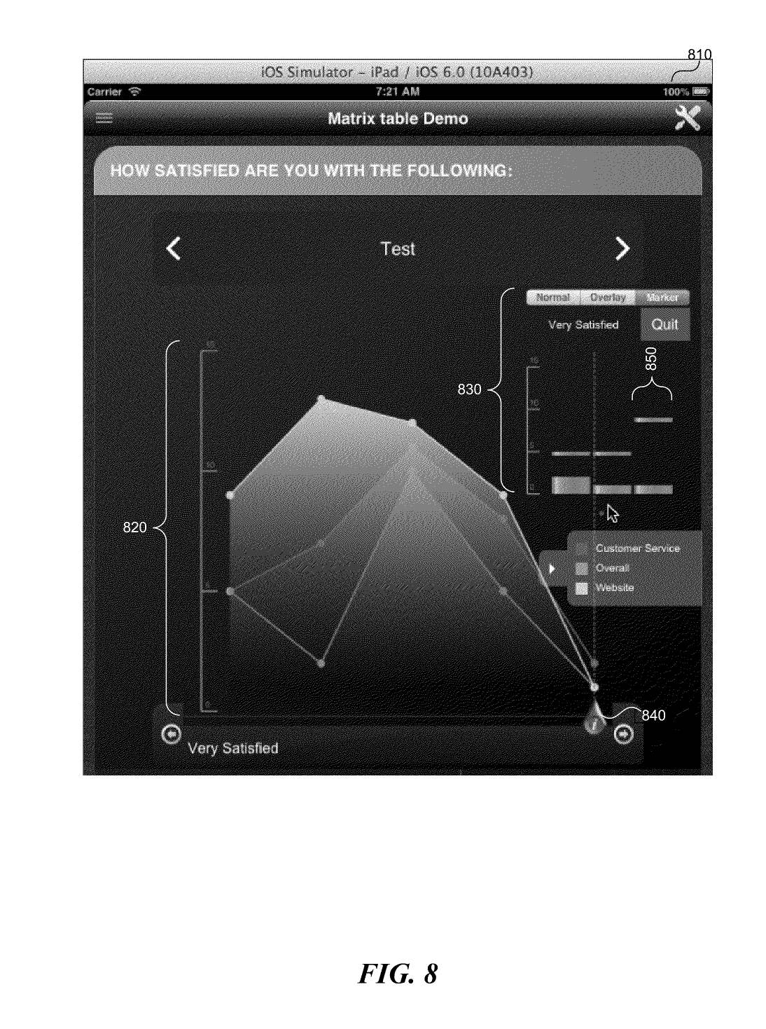

FIG. 8 is a display diagram that illustrates a graphical user interface provided by the data comparison and insight system to illustrate a marker comparison visualization, in one embodiment. The display 810 includes a main visualization 820 that displays a line chart of matrix survey data for satisfaction levels with an organization's customer-facing operations, such as a website and customer service department. The display 810 also includes a dynamic inset visualization 830 that shows the relative responses of respondents. The dynamic inset visualization is showing two datasets integrated into the same chart. Each bar 850 illustrates a baseline data point as a marker line set at the baseline level (e.g., where the top of the baseline bar would be if the baseline level were displayed as a full bar), and a comparison data point as a normal bar. The marker may be displayed darker in color, brighter, or in some other manner that allows it to be seen even when the comparison data bar is underneath it (i.e., when the comparison data point has a higher value than the baseline). As the user moves the selection point 840, the comparison bar changes while the baseline marker stays the same. This allows the user to see any particular dataset in comparison to the baseline.

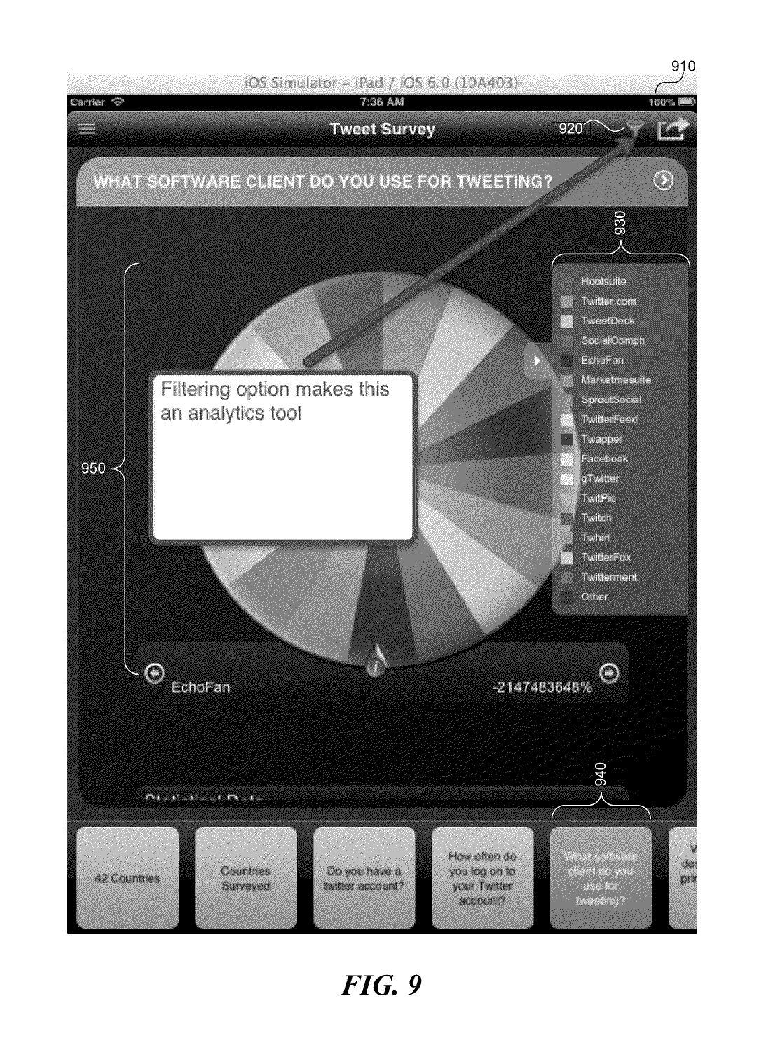

FIG. 9 is a display diagram that illustrates a graphical user interface provided by the data comparison and insight system to illustrate activating filtering, in one embodiment. The display 910 includes a displayed visualization 950 that is related to a selected question 940. The illustrated question has a wide variety of possible responses 930. By activating the filtering button 920, the user can define a filter and/or apply a previously defined filter to include or exclude particular data. As a result of the filtering, the displayed visualization 950 will update to show the remaining data that satisfied the selected filter.

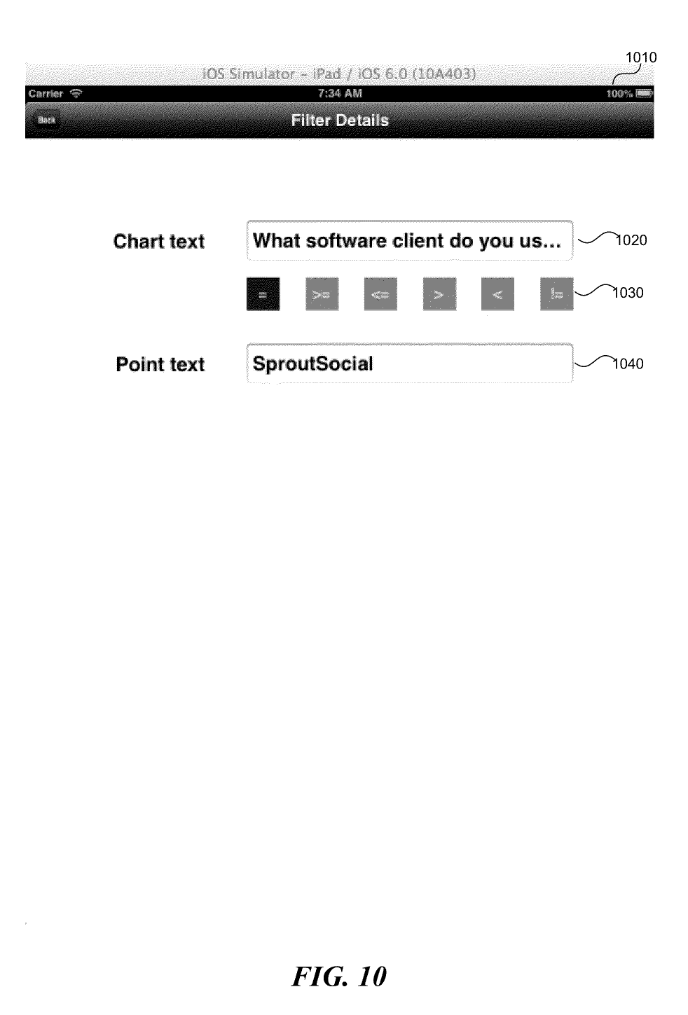

FIG. 10 is a display diagram that illustrates a graphical user interface provided by the data comparison and insight system to illustrate defining a filter, in one embodiment. The display 1010 provides a text box 1020 for defining matching chart text, an operator selection area 1030, and a text box 1040 for defining a matching value. Responses that match the chart text provided in text box 1020 and have the value provided in text box 1040 will match the filter when the operator 1030 is “equals”. Other operators perform their normal arithmetic or logical operations.

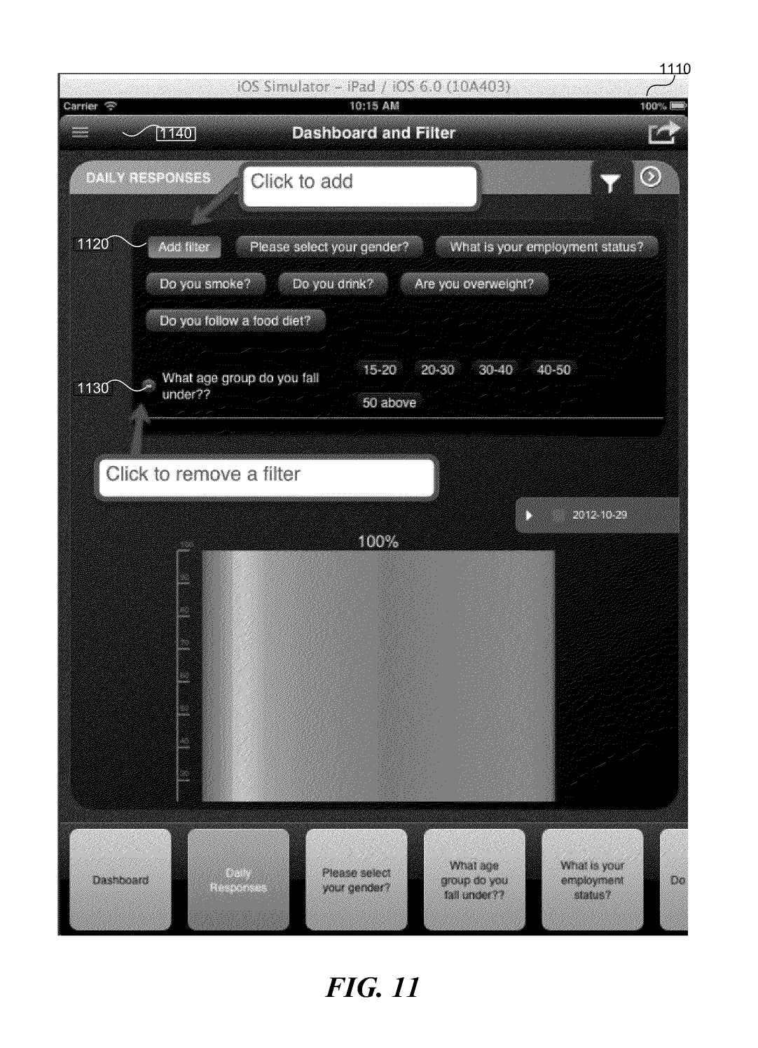

FIG. 11 is a display diagram that illustrates a graphical user interface provided by the data comparison and insight system to illustrate editing filters, in one embodiment. The display 1110 provides a list of filters, such as the filter defined in FIG. 10. The display includes a control 1120 for adding new filters and a control 1130 next to each filter for removing that filter. The system may display this interface in response to the user selecting the filter button of FIG. 9, so that the user can define filters, remove filters, and turn filters on and off. When the user is done defining filters, the system may return the user to the display of FIG. 9 with the visualization updated based on the user's filtering selections.

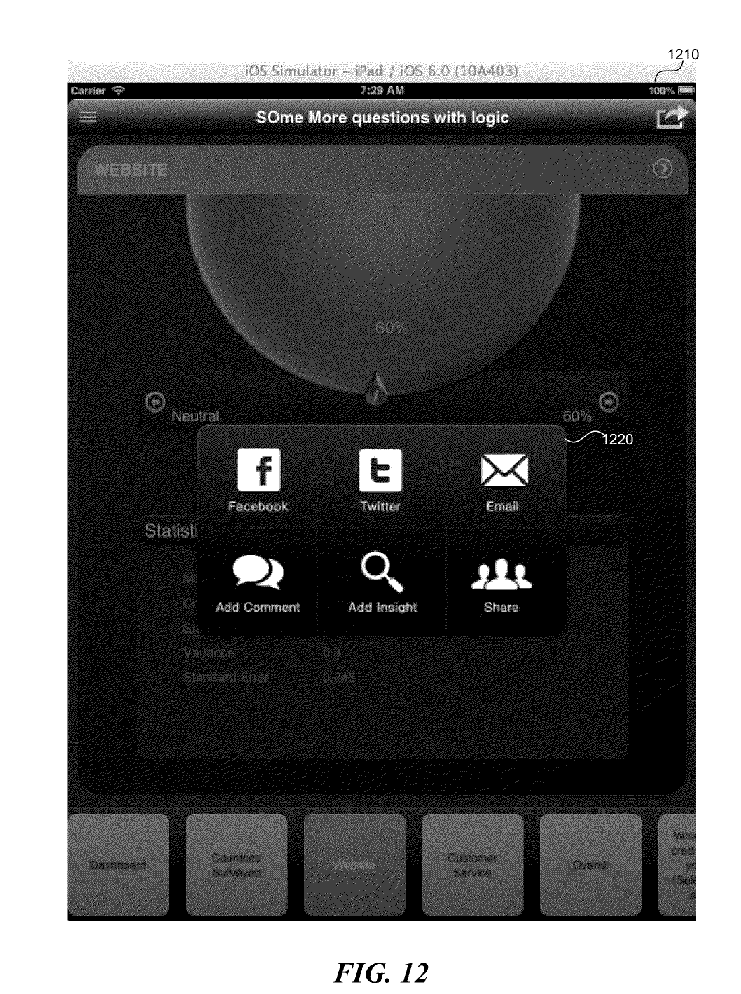

FIG. 12 is a display diagram that illustrates a graphical user interface provided by the data comparison and insight system to illustrate adding insights and sharing data, in one embodiment. The display 1210 includes a dialog box 1220 with various options for sharing data and adding user observations. For example, the user can share data via Facebook, Twitter, email, or other sharing options. The user can also add a comment and/or insight to the data and displayed visualization.

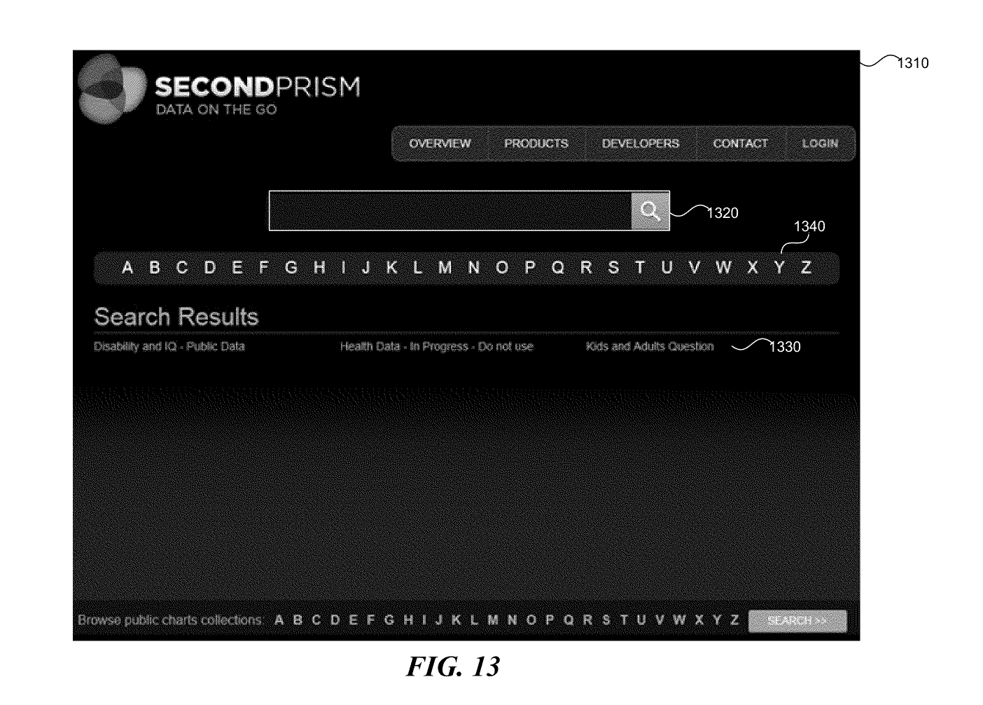

FIG. 13 is a display diagram that illustrates a graphical user interface provided by the data comparison and insight system to illustrate searching for shared datasets, in one embodiment. For example, the display 1310 may be provided by a web page exposed publicly through the Internet or within an organization on an intranet. The display 1310 includes a search box 1320, a list of search results 1330, and controls 1340 for navigating to data. The search box 1320 receives a search query from a user and locates matching search results 1330. The user can click or select search results 1330 to view visualizations based on the selected result. The system may also provide ways other than search for finding data, such as the set of letter controls 1340 that allow the user to navigate to particular datasets based on the letter they start with.

From the foregoing, it will be appreciated that specific embodiments of the data comparison and insight system have been described herein for purposes of illustration, but that various modifications may be made without deviating from the spirit and scope of the invention. Accordingly, the invention is not limited except as by the appended claims.

I/We claim:

1. A computer-implemented method to display comparison data for multiple datasets in a single chart, the method comprising:
receiving a selection of a first multidimensional dataset to compare with a second multidimensional dataset;
displaying a main visualization that displays a range of data points of the selected multidimensional dataset;
receiving a selection of a baseline data point to use as a basis for comparing other data points;
receiving a selection of a secondary data point to compare with the baseline data point;
gathering data associated with the selected baseline and secondary data point and preparing a comparison of the data for visual display; and
displaying the selected baseline and secondary data points together in a unified comparison visualization,
wherein the preceding steps are performed by at least one processor.

2. The method of claim 1 wherein receiving the datasets comprises receiving an indication of two different data points of a matrix survey question, wherein each data point includes a related dataset.

3. The method of claim 1 wherein receiving the datasets comprises receiving a selection from a user from a repository of datasets provided by a data search website.

4. The method of claim 1 wherein receiving the datasets comprises accessing externally stored data through a data source provider that gathers and formats the data to prepare the data for use in a touch-based visualization.

5. The method of claim 1 wherein displaying the main visualization comprises leveraging a touch interface that allows the user to touch the visualization to see additional data.

6. The method of claim 1 wherein displaying the main visualization comprises providing the main visualization as a majority of a display area of a mobile device and displaying the comparison visualization as a smaller inset that dynamically updates based on the user selecting different secondary data points.

7. The method of claim 1 wherein receiving the baseline data point comprises receiving a selection from the user from the displayed main visualization.

8. The method of claim 1 wherein receiving the baseline data point comprises updating a previously selected baseline data point to a new baseline data point.

9. The method of claim 1 wherein receiving the secondary data point comprises receiving an indication that a user moved a visually displayed user interface control that indicates a current data point.

10. The method of claim 1 wherein receiving the secondary data point comprises receiving additional comparison data points for comparison with the baseline data point and other received data points.

11. The method of claim 1 wherein preparing comparison data for display comprises calculating percentages that indicate a distribution of values for the selected data points, wherein the calculated percentages are displayed based upon receiving a user request.

12. The method of claim 1 wherein preparing comparison data for display comprises applying a previously defined filter to the data.

13. The method of claim 1 wherein displaying the comparison visualization comprises displaying the comparison dataset overlaid on the baseline dataset.

14. A computer system for interactive data comparison and insight sharing using mobile, touch-based computing hardware, the system comprising:
a processor and memory configured to execute software instructions embodied within the following components;
one or more data source providers that gather data from one or more data sources;
one or more data brokers that modify data received from the one or more data sources to prepare the received data for display in a visualization;
a baseline selection component that receives a selection of a dataset that will form a baseline against which to compare one or more other datasets received from the data source providers;
a data comparison component that compares the selected baseline dataset with the one or more comparison datasets;
a comparison visualization component that generates one or more visualizations for visually comparing data in two or more datasets;
an insight tracking component that collects and stores data insights from users including an identification of particular data associated with each insight;
an insight sharing component that communicates insights from one user to another including the identification of particular data associated with each insight; and
a data search component that provides a searchable repository of datasets.

15. The system of claim 14 wherein the one or more data source providers invoke a representational state transfer (REST)/JavaScript Object Notation (JSON)-based application programming interface (API) of one or more data sources to access data.

16. The system of claim 14 wherein at least one data broker provides third party branding of a user interface provided by the system.

17. The system of claim 14 wherein at least one data broker provides filtering of received data so that the filtered data can be displayed and compared in one or more visualizations.

18. The system of claim 14 wherein the comparison visualization component combines visualization data for multiple datasets and displays multiple data dimensions side by side for comparison.

19. The system of claim 14 wherein the insight tracking component infers insights based on time spent by a user looking at particular data.

20. A computer-readable storage medium comprising instructions for controlling a computer system to receive an insight for sharing with other users, cause a processor to perform actions comprising:
receiving a selection of a dataset to analyze;
displaying a visualization related to the selected dataset that visually displays at least part of the data in the dataset;
receiving an insight from the user that logs a relevant point in the data identified by the user;
associating the received insight with the relevant point in the data to which the insight pertains;
storing the received insight and association with the relevant point in the data for future use by the user and other users; and
receiving a request to share a stored insight with another user, and sending a reference to the insight to the user in a communication.
